(19) United States
(12) Patent Application Publication
(10) Pub. No.: US 2009/0143889 A1
(43) Pub. Date: Jun. 4, 2009

(54) Equipment operating status tracking system

(76) Inventors: Kevin C. Brady, San Marcos, CA (US); Ralph Alexander Gordon, San Diego, CA (US); Mark S. Knodle, Encinitas, CA (US); Marco X. Perez, Chula Vista, CA (US); Joseph Stinson McElhinney, IV, San Diego, CA (US)

Correspondence Address: CATERPILLAR/FINNEGAN, HENDERSON, L.L.P., 901 New York Avenue, NW, WASHINGTON, DC, 20001-4413, US

(21) Appl. No.: 11/998,409

(22) Filed: Nov. 30, 2007

(51) Int. Cl. G06F 19/00

(52) U.S. Cl. 700/108

(57) ABSTRACT

An equipment operating status tracking system is provided, which may include a graphical user interface (GUI), a processor, and a computer-readable medium operatively coupled to the processor. The computer-readable medium may include a memory in which are stored instructions for receiving operating status data for at least one piece of equipment and automatically, initially categorizing any downtime in the operating status data as uncharacterized. The computer-readable medium may include instructions for displaying at least some of the operating status data, including the uncharacterized downtime, to a user authorized to characterize downtime. Further, the computer-readable medium may include instructions for receiving input from the authorized user to characterize the downtime by selecting from a plurality of characterization categories, each category being indicative of a different cause of downtime. In addition, the computer-readable medium may further include instructions for displaying the characterized downtime.

### TECHNICAL FIELD

The present disclosure is directed to an equipment operating status tracking system and, more particularly, to an equipment operating status tracking system having limited user access to characterize downtime.

### BACKGROUND

For various industries, the availability and reliability of a corporation's equipment are significant factors in the corporation's productivity and, therefore, profitability. Because of this relationship, even slight variations in availability and/or reliability can have a substantial financial impact on the corporation. Accordingly, it is desirable to maximize the availability and reliability of such equipment. However, in order to maximize availability and reliability, accurate and meaningful data regarding the operating status of the equipment must be available for analysis.

In many cases, data may be collected automatically. However, one limitation of purely automatic data collection is that, although automatically-collected (“raw”) data may indicate whether, and for how long, a piece of equipment was operating or “down” during a given time period, the raw data does not reflect why the equipment was down. The reliability of equipment cannot be accurately assessed unless it is known whether the downtime recorded was the result of planned maintenance or some other unplanned reason (e.g., breakdown, failure, etc.). Additionally, in the case of equipment failure, raw data does not reflect whether failure is due to manufacturer defect or improper customer use (e.g., use of improper fuel).

Traditionally, a fleet manager, who may be in charge of managing the operation of one or more pieces of equipment, may manually prepare reports that attempt to characterize downtime. However, that is a cumbersome and inconsistent process. Further, the resulting information/data compiled in such reports is not typically stored in the same database and/or system in which the raw data was collected. Therefore, different sets of results from different reports such as these may not be compared to one another as easily as if the data collection, characterization of downtime, and reporting were all performed using the same system or using systems compatible with one another.

Some systems have been developed that attempt to improve the characterization of downtime by automating the characterization of downtime or by enabling equipment operators to characterize the downtime manually. For example, U.S. Pat. No. 5,841,964 to Yamaguchi discloses an operating state management system, whereby initial characterization of downtime is performed automatically. In the system disclosed in the '964 patent, downtime may need to be recharacterized if it turns out later that, for example, a trouble shutdown was actually planned. Therefore, there can be a period of time where downtime can be mischaracterized, thus reflecting an inaccurate assessment of the equipment's operational history. For example, when downtime is mischaracterized, the data will show the equipment to be either more or less available and more or less reliable than it actually is. Further, if the mischaracterized downtime is overlooked and, therefore, never recharacterized, the availability and reliability data will remain inaccurate indefinitely.

The present disclosure is directed at improvements in existing equipment availability tracking systems.

### SUMMARY

In one aspect, the present disclosure is directed to an equipment operating status tracking system. The system may include a graphical user interface (GUI), a processor, and a computer-readable medium operatively coupled to the processor. The computer-readable medium may include a memory in which are stored instructions for receiving operating status data for at least one piece of equipment and automatically, initially categorizing any downtime in the operating status data as uncharacterized. The computer-readable medium may also include instructions for displaying, on the GUI, at least some of the operating status data, including the uncharacterized downtime, to a user authorized to characterize downtime. Further, the computer-readable medium may include instructions for receiving input from the authorized user to characterize the downtime by selecting from a plurality of characterization categories, each category being indicative of a different cause of downtime. In addition, the computer-readable medium may further include instructions for displaying the characterized downtime on the GUI.

In another aspect, the present disclosure is directed to a method of tracking operating status of equipment. The method may include receiving operating status data for at least one piece of equipment onto a computer-readable medium and using a processor operatively coupled to the computer-readable medium to automatically, initially categorize any downtime in the operating status data as uncharacterized. The method may also include displaying, on a graphical user interface (GUI), at least some of the operating status data, including the uncharacterized downtime, to a user authorized to characterize downtime. The method may further include receiving input from the authorized user to characterize the downtime by selecting from a plurality of characterization categories, each category being indicative of a different cause of downtime. In addition, the method may include displaying the characterized downtime on the GUI.

### BRIEF DESCRIPTION OF THE DRAWINGS

FIG. 1 is a block diagram representing components of an operating status tracking system according to an exemplary disclosed embodiment.

FIG. 2 is a diagrammatic illustration of an exemplary user search interface of the system shown in FIG. 1.

FIG. 3 is a diagrammatic illustration of an exemplary user characterization interface of the system shown in FIG. 1.

FIG. 4 is a chart illustrating portions of a process of characterizing operating status data and calculations of availability and reliability data.

FIG. 5 is a diagrammatic illustration of an exemplary reviewing and printing interface of the system shown in FIG. 1.

### DETAILED DESCRIPTION

Reference will now be made in detail to the drawings. Wherever possible, the same reference numbers will be used throughout the drawings to refer to the same or like parts.

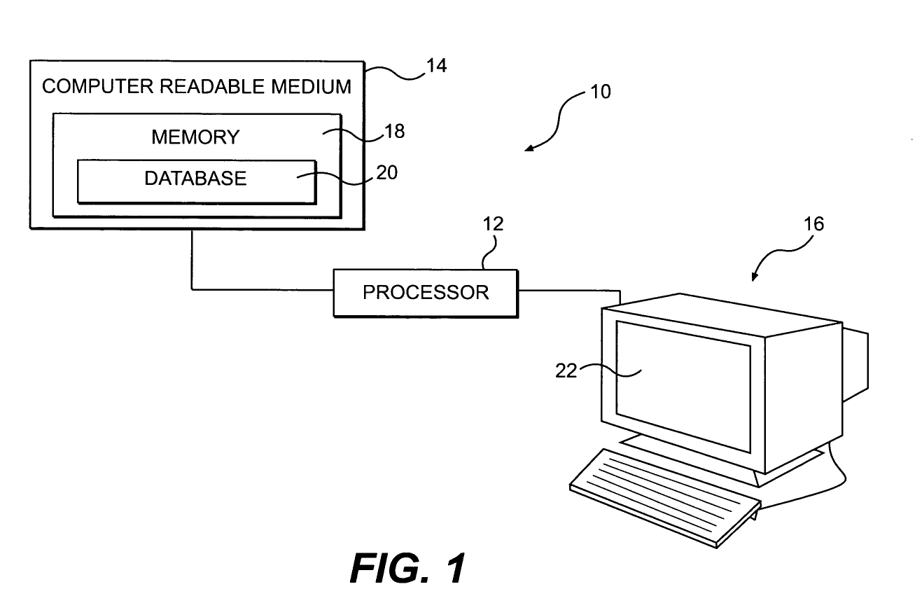

FIG. 1 illustrates an equipment operating status tracking system 10. System 10 may include a processor 12, a computer-readable medium 14 operatively coupled to processor 12, and a graphical user interface (GUI) 16.

Computer-readable medium 14 may include a memory 18 in which may be stored collections of data and instructions for performing functions associated with system 10. Computer-readable medium 14 may include any type of computer-readable medium including, for example computer chips and secondary storage devices, including hard disks, floppy disks, optical media, CD-ROM, or other forms of RAM or ROM. Computer-readable medium 14 may include instructions for receiving operating status data for at least one piece of equipment. Such data may be stored in computer-readable medium 14 in, for example, at least one database 20.

In some embodiments, computer-readable medium 14 may include two or more distinct computer-readable media. In some cases, these distinct computer-readable media may be located at different facilities. For example, where a monitoring facility is separate from the equipment facility, each facility may include a computer-readable medium and processor for handling operating status data. In some embodiments, the equipment facility may include a data collection computer configured to record, store, and transfer operating status data. In such embodiments, the monitoring facility may include a data processing computer configured to receive, process, and display operating status data. In other embodiments, the computers at the two facilities may share data collection, processing, and display responsibilities somewhat differently.

GUI 16 may include any type of display device or equipment. For example, GUI 16 may include a display 22, which may be configured to provide visual feedback regarding system 10 and its components and functions. Display 22 may be any kind of display, including, for instance, a screen display, as shown in FIG. 1. For example, display 22 may include a cathode ray tube (CRT), liquid crystal display (LCD), plasma screen, or the like. In addition to providing visual feedback regarding functions of system 10, display 22 may also be configured to accept input. In such an embodiment, display 22 may include, for example, a touch screen. Display 22 may also provide other information regarding any other device and/or system associated with system 10.

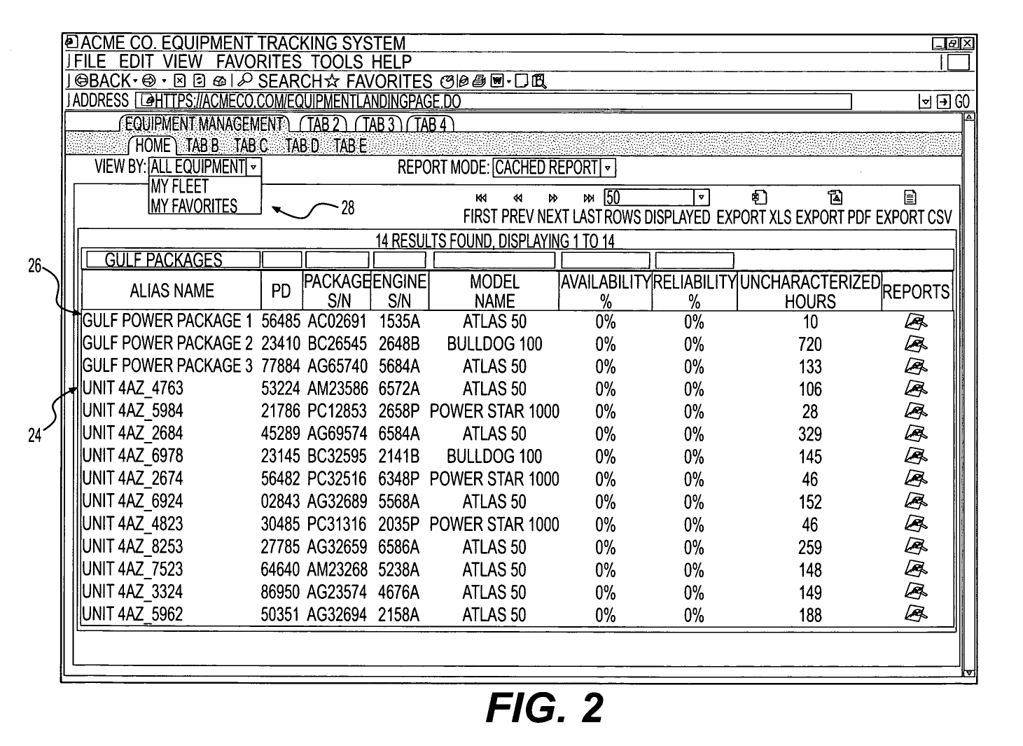

System 10 may be implemented on a local network, e.g., within a manufacturing facility or within a manufacturing company. In some embodiments, the network of system 10 may be accessible to certain users external to the facility. For example, system 10 may be Internet-based and, as such, may be displayed by display 22 as one or more web pages available on a local or global network. Therefore, in some embodiments, computer-readable medium 14 may include instructions for displaying and receiving information regarding the operating status data via a web-based interface, as shown in FIGS. 2-4.

Because equipment failure and other equipment management issues are typically reported to a fleet manager, the fleet manager is usually the person with the most intimate knowledge of the equipment's operation and may also be the person most familiar with the most pieces of equipment (i.e., the fleet of equipment that he is responsible for managing). In contrast, site managers may only be familiar with the equipment at their own facilities. Thus, it is the fleet manager who is often in the best position to characterize operating status data. For purposes of this disclosure the term fleet manager may include a single person or, in some embodiments, a single fleet management entity, such as a fleet management company.

In some cases, the equipment manufacturer itself may manage the fleet or fleets of equipment that it sells. For example, it is common in some industries for manufacturers/dealers of equipment to have service contracts, sometimes called customer service agreements (CSAs), with customers who purchase or lease equipment from them. These agreements may contain guarantees by the manufacturer/dealer that the equipment will operate with at least a minimum availability and/or minimum reliability. In such case, the manufacturer/dealer may monitor the operating status data for the equipment covered by the agreement.

In some cases, the CSAs may cover more than one type of component at each site. For example, a CSA for a petroleum product mining system may cover a driver, such as a gas turbine engine; a piece of equipment driven by the engine, such as a compressor; and other equipment associated with the harvesting process, such as yard valves. In some cases, however, despite a CSA covering all this equipment, a manufacturer's business may be more focused a certain piece or pieces of equipment covered by the CSA. For example, a manufacturer's primary business may involve producing gas turbine engines. Therefore, even though the manufacturer may honor a CSA covering a variety of components utilized in a process, the manufacturer may wish to distinguish between the components as far as guarantees of availability and reliability. Accordingly, to track availability and reliability of individual components, system 10 may be configured to facilitate processing operating status data to provide data that differentiates between the performances of individual pieces of equipment. This concept will be discussed in greater detail below with respect to characterization of operating status data.

User access to system 10 and/or various aspects thereof may be regulated based on a plurality of security access categories. For example, various categories and/or levels of security access granted to a user may be based on whether or not the user is an in-house user of an organization hosting system 10 (e.g., an employee of the host organization) or an outside user (e.g., a contract employee, vendor, etc.); the type of work the user does; the geographic region in which the user works; the business facility at which the user works; etc.

Different levels of security access may grant users access to various aspects and/or features of system 10. For example, depending on the level of security access a user has been granted, the user may or may not have access rights to view and/or characterize operating status data stored in database 20. In some embodiments, fleet managers may be granted access rights to view all data in database 20. In other embodiments, fleet managers may be granted access only to data for the equipment for which they are responsible. Whereas fleet managers may be allowed to view and characterized data for an entire fleet, certain users, such as a site manager, may be only allowed to view data for the equipment at their own site. In other embodiments, it may be desirable to allow site managers to view data for the entire fleet. This concept is discussed below in greater detail.

Computer-readable medium 14 may include instructions for accepting input from authorized users to create an alias name for each piece of equipment to facilitate review of the operating status data or other information regarding the equipment. For example, FIG. 2 is a depiction of a web-based interface, listing some pieces of equipment having long and/or cumbersome names, such as “UNIT 4A2_{—}4763” shown in box 24. Therefore, system 10 may provide the ability for users to create an alias that is more recognizable to users of system 10. If an alias has been created, such as “Gulf Power Package 1,” the alias may replace the equipment's more cumbersome name in the display of data, as shown in box 26.

Although system 10 may be used to track the operating status of a single piece of equipment, in some embodiments, system 10 may be configured to track the operating status of a fleet of equipment including two or more pieces of equipment. The fleet of equipment may include pieces of equipment at two or more facilities. For example, because system 10 may be web-based, system 10 may be used to track operation of a fleet that is distributed among multiple facilities all across the world.

In some embodiments, computer-readable medium 14 may include instructions for displaying, on GUI 16, the operating status data for a fleet of equipment including two or more pieces of equipment. In such embodiments, computer-readable medium 14 may include instructions for isolating and displaying operating status data for individual pieces of equipment in the fleet. For example, as shown in FIG. 2, users may be enabled to filter which equipment is displayed. Users may be able to view data for all equipment in database 20 or select from one or more data subgroups. For example, users may be able to retrieve information for just the equipment within a particular fleet. A fleet manager may choose “my fleet” or create a set of “favorites.” These choices may be made, for example, with a drop down menu 28, by which the user can filter the data.

Computer-readable medium 14 may include instructions for receiving operating status data automatically collected for at least one piece of equipment. Operating status data for one or more pieces of equipment at one or more facilities may be collected and stored in database 20. In some embodiments, data collection may be performed on site at each facility, e.g., by downloading data collected and stored on site. In other embodiments data may be automatically transmitted or transmitted upon demand to, for example, a remote monitoring facility. This data transmission may be via radio transmission, satellite, or other mean of communication. In some embodiments, particularly those employing web-based interfaces, data collection/transmission may be facilitated by the Internet.

Operating status data may be collected as blocks of time. For example, system 10 may receive data including blocks of time initially categorized into one of several characterization categories. Some data may be automatically, initially characterized. Other data may be automatically, initially categorized as “uncharacterized.” For example, when the equipment is running, there is usually no debate about what the operating status of the equipment is. Therefore, all running hours may be automatically, initially characterized as “running.” Other data, such as downtime and/or time with missing operating status data, may be automatically, initially categorized as “uncharacterized.” This ensures that this data will be characterized by a user authorized to characterize operating status data who is familiar with the operational history of the equipment, e.g., a fleet manager. This may enable the reason for the downtime or missing data to be determined and factored into which characterization category the time will be placed (e.g., planned downtime or unplanned downtime).

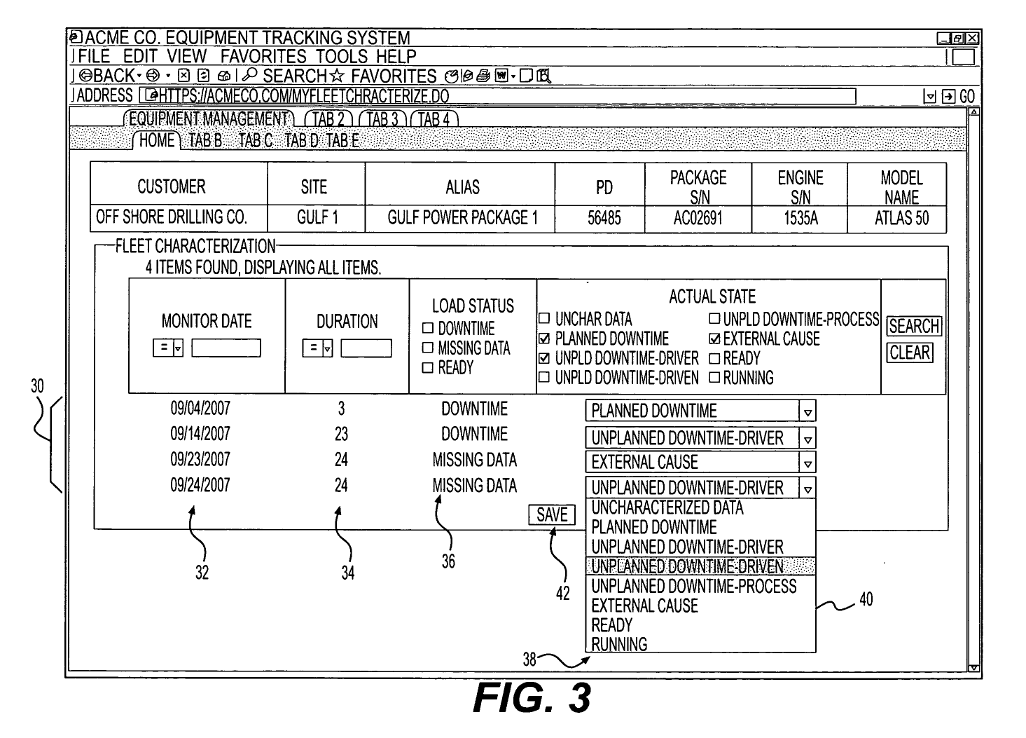

Computer-readable medium 14 may further include instructions for displaying at least some of the operating status data, including any uncharacterized operating status data, on GUI 16. This data may be made available for viewing by authorized users of system 10. System 10 may allow fleet managers or other authorized users to query database 20 where collected data may be stored, to examine metrics for operating status data. A user may search for one or more categories of operating status data for a given time period. For example, a user may search for, and retrieve, all uncharacterized data for one or more pieces of equipment for a particular month. This search capability is shown in exemplary fashion in FIG. 3.

FIG. 3 illustrates a web-based interface which may be displayed upon selecting Gulf Power Package 1 in FIG. 2. Once at the interface shown in FIG. 3, a user may then perform a custom search of the operating status data for Gulf Power Package 1. Shown in a results section 30 are hypothetical search results for any data that has been characterized as PLANNED DOWNTIME, UNPLANNED DOWNTIME-DRIVER, OR EXTERNAL CAUSE. A date column 32 lists the date the data was retrieved, a time column 34 lists the amount of time (in hours) that the event lasted, and an initial categorization column 36 lists the initial categorization of the data (e.g., ready, running, downtime, or missing data).

System 10 may be configured to receive input from an authorized user, e.g., a fleet manager, to characterize operating status data by selecting from a plurality of characterization categories. A characterization column 38 enables an authorized user to characterize (or recharacterize) the data by, for example, using a dropdown menu 40. There may be several different categories of downtime, wherein each downtime category is indicative of a different cause of the downtime. For example, downtime may be characterized as “planned” or “unplanned.” In some embodiments, the time in each block of data may be subcategorized. For example, if an event is initially logged as 10 hours of downtime, the user may be able to characterize 5 of those hours as planned downtime and the other 5 hours as unplanned downtime.

Initially, operating status data may be automatically categorized as READY, RUNNING, DOWNTIME, or MISSING DATA. In some embodiments, system 10 may be configured to automatically, initially characterize Ready time and Running time as READY and RUNNING, respectively. In addition, system 10 may automatically, initially categorize Downtime and Missing Data as UNCHARACTERIZED. In other embodiments, system 10 may automatically, initially categorize all operating status data, including Ready and Running time, as UNCHARACTERIZED.

Authorized users may be allowed to recharacterize any Running or Ready data. In addition, authorized users may be allowed to characterize any uncharacterized data by selecting from a plurality of characterization categories. As shown in drop down menu 40, authorized users may choose from categories such as READY, RUNNING, PLANNED DOWNTIME, UNPLANNED DOWNTIME-DRIVER, UNPLANNED DOWNTIME-DRIVEN, UNPLANNED DOWNTIME-PROCESS, and EXTERNAL CAUSE. Once data has been characterized, users may click a save button 42, which will then refilter the data so that any data which, based on its updated characterization, does not meet the search criteria will be removed from the list.

As discussed above, customer service agreements (CSAs) may cover multiple components of a system. The individual performance of each component may be tracked by system 10 because system 10 may enable authorized users to choose between multiple characterization categories, wherein a different characterization category is associated with each component. For purposes of illustration, a hypothetical example will be discussed, wherein a CSA covers equipment involved in a petroleum product harvesting process. The equipment covered by the hypothetical CSA may include a gas turbine engine (the driver), a compressor (the driven equipment), and yard valves (i.e., equipment, other than the driver or driven equipment, that is associated with the process).

For the hypothetical example, any unplanned downtime due to a problem with the gas turbine engine may be characterized as UNPLANNED DOWNTIME-DRIVER. Any unplanned downtime due to a problem with the compressor may be characterized as UNPLANNED DOWNTIME-DRIVEN. Any unplanned downtime due to a problem with the yard valves may be characterized as UNPLANNED DOWNTIME-PROCESS. Any problem with components that are not covered by the CSA may be characterized as EXTERNAL CAUSE. Further, any problem caused by user error, such as putting the wrong fuel in the engine, may also be characterized as EXTERNAL CAUSE.

Computer-readable medium 14 may include instructions for determining availability and reliability of the equipment by using processor 12 to process characterized operating status data to generate availability and reliability data. In some embodiments, the availability and reliability of a piece of equipment during a time period may be determined by the processor only if all operating status data collected during that time period has been characterized. This may promote accuracy of the availability and reliability assessments.

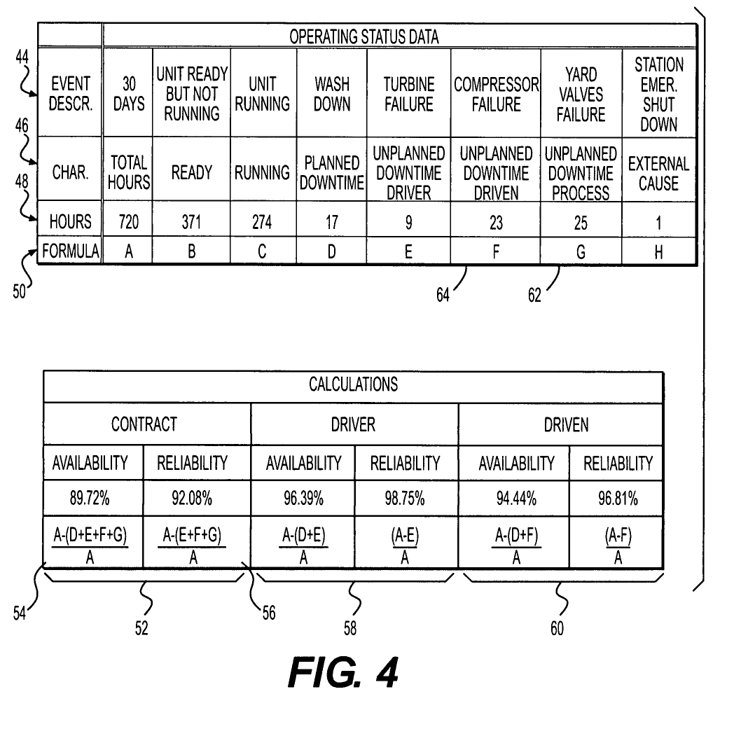

FIG. 4 illustrates some of the characterization process, as well as the process of determining availability and reliability. FIG. 4 is a chart including hypothetical operating status data for some equipment over a 30 day period, as well as information about the events that occurred during the 30 day period that influenced the operating status of the equipment. For purposes of this example, the equipment from which data has theoretically been collected is under a CSA, which covers a gas turbine engine, a compressor driven by the turbine, and yard valves associated with the overall system.

In FIG. 4, the top portion of the chart includes operating status data. The description of various hypothetical events that have occurred during the 30 day period that this data was collected are listed in an event description row 44. The characterization categories with which the various events correspond are listed in a characterization row 46. The time (in hours) that each event lasted is listed in an hours row 48. A formula row 50 lists a letter associated with each characterization category (and also the total hours).

In this example, the letters in formula row 50 are used to represent the hours from the respective characterization categories in the formulas in the bottom portion of the chart, which may be used to calculate availability and reliability. There may be various ways in which availability and reliability may be calculated. These types of calculations are generally known in the art, and any suitable calculations for availability and reliability may be used by processor 12 in making the calculations during execution of the disclosed method of using system 10.

A fleet manager would either know about, or investigate, each period of uncharacterized time. Therefore, ultimately, the fleet manager should be able to determine what type of event occurred during each period of time that is automatically, initially categorized as uncharacterized. The fleet manager should know that an equipment wash down should be characterized as PLANNED DOWNTIME. Similarly, the fleet manager would characterize time for a turbine failure as UNPLANNED DOWNTIME-DRIVER, time for a compressor failure as UNPLANNED DOWNTIME-DRIVEN, and time for yard valve failure as UNPLANNED DOWNTIME-PROCESS.

In this example, the listed station emergency shut down was not caused by any equipment covered by the hypothetical CSA, and thus, the fleet manager would characterize time for this shut down as EXTERNAL CAUSE. For the same reason, if; unlike in this example, the yard valves or compressor were not covered by the CSA, the fleet manager would characterize the time for problems with these components as EXTERNAL CAUSE, and not as unplanned downtime. This difference in characterization affects the results of the availability and reliability calculations, which are discussed in greater detail below.

As shown in FIG. 4, availability and reliability of the equipment covered by CSA is shown in a contract section 52. Availability of the equipment covered by the CSA may be determined by subtracting planned downtime (D) and unplanned downtime (E+F+G) from the total amount of time in the time period (A) and dividing by the total amount of time in the time period (A). (See box 54.) As also shown in FIG. 4, the reliability of the equipment covered by the contract may be determined by subtracting unplanned downtime (E+F+G) from the total amount of time in the time period (A) and dividing by the total amount of time in the time period (A). (See box 56.)

Availability and reliability calculations for the gas turbine engine in this example are shown in a driver section 58. Availability and reliability calculations for the compressor are shown in a driven section 60. As this example demonstrates, the availability and reliability of the individual components of some systems may be different for each component. In this example, the availability and reliability of the collection of contract components are notably lower than the availability and reliability of the turbine and the compressor individually. This is because when calculating availability and reliability for both the turbine and the compressor, unplanned downtime due to problems with the yard valves, which is significant (25 hours, as shown in box 62), is not considered. The availability and reliability of the turbine are highest because, not only do the calculations for these omit the unplanned downtime for the yard valves, but these calculations also do not consider the unplanned downtime of the compressor (23 hours, as shown in box 64).

Although not shown in FIG. 4, system 10 may also be configured to calculate utilization. Formulas for determining utilization are also generally known in the art and typically involve dividing running time by total hours for the period in question.

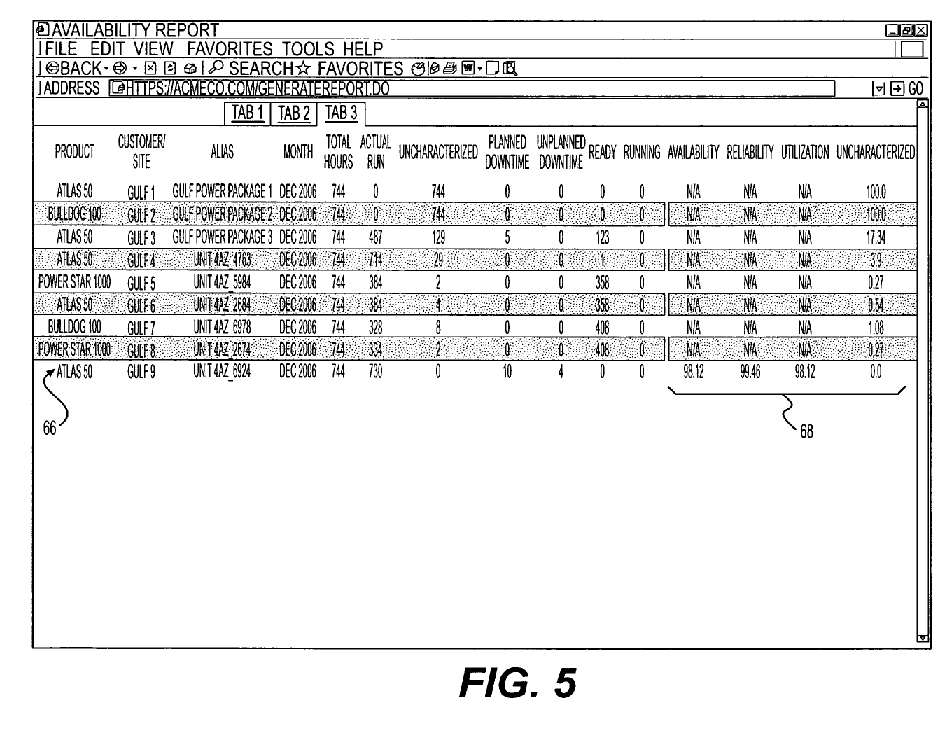

Computer-readable medium 14 may include instructions for displaying the availability and reliability data on GUI 16, as shown in FIG. 5. Although FIG. 5 shows the data in tabular form, the availability data and/or the reliability data may, additionally or alternatively, be displayed in graphical forms or in any other suitable manner.

The displayed information may relate to a single piece of equipment, a fleet including two or more pieces of equipment, equipment dispersed among different geographic locations, and/or even multiple fleets of equipment. Further, the information may be organized in any suitable way for the number, type, and location of the pieces of equipment being tracked. The more up to date this information is, in terms of any periods of missing data or downtime being characterized by a fleet manager, the more meaningful the information will be to interested parties, because the information will more accurately reflect the reliability of the equipment and/or the efficiency with which the equipment is being utilized.

As shown in FIG. 5, only one of the units displayed (in row 66) lists no uncharacterized hours. This is the only unit for which system 10 has calculated availability, reliability, or utilization. (See calculations section 68.) Users may use the interface shown in FIG. 5 to view the data and/or to print the results shown therein.

### INDUSTRIAL APPLICABILITY

The disclosed system may be configured to compile, analyze, process, and report operating status data of equipment, including availability and reliability data. The disclosed system may be applicable to any equipment for which consistent operation thereof is of concern to interested parties. For example, the system may be applicable to tracking operation of power generation equipment, such as electric power generator sets; oil harvesting equipment, such as pumps; manufacturing equipment, such as presses; etc.

Through specific characterization of certain data, the disclosed system may facilitate faster, easier, and more accurate assessment of equipment availability and reliability. Because a piece of equipment, in theory, creates profit whenever it is operating properly, an owner would, ideally, want the piece of equipment to run 24 hours a day, 365 days per year. Raw, automatically-collected data may indicate how many hours out of the year (or some other period of time) the equipment was running. However, the disclosed system may enable analysis to determine how much of the time the equipment was not only running, but available and/or reliable.

An advantage of the disclosed system may be that by providing a uniform, convenient way to characterize data, availability/reliability evaluations may be consistent from one facility to another. For example, if the same type of equipment is operated at two different facilities, the characterized data may be compared between the two facilities. One facility may operate with less downtime, and the more detailed information that is available about the downtime, the better an owner will be able to discern what practices of the better performing facility result in the higher performance. For example, perhaps one facility takes 6% planned downtime for scheduled maintenance (i.e., instead of only 5%). It is possible that the extra 1% of planned downtime for scheduled maintenance may enable the unit to operate with 2% fewer hours of downtime due to failure. Therefore, a net improvement of 1% running time may be realized even though a larger amount of downtime is planned.

Another advantage of the disclosed system is that, because, in some embodiments, any downtime may be automatically, initially categorized as “UNCHARACTERIZED,” and the fleet manager may be the only entity with authorization to characterize the downtime for the fleet, the disclosed system may promote consistency in the characterization of operating status data. This can be desirable when the fleet is distributed among multiple facilities, because it may result in more accurate and uniformly characterized data. With more accurately and uniformly characterized data, optimization of equipment use may be greatly facilitated and/or enhanced. In addition, such data may be sought by not only owners, but also manufacturers, who may utilize the data in the research and development of equipment enhancements and/or new equipment.

In some embodiments an exemplary method of tracking operating status of equipment may include receiving operating status data for at least one piece of equipment onto a computer-readable medium. The method may also include using a processor operatively coupled to the computer-readable medium to automatically, initially categorize any downtime in the operating status data as uncharacterized. Further, the method may include displaying at least some of the operating status data, including the uncharacterized downtime, to a user authorized to characterize downtime. In addition, the method may include receiving input from the authorized user to characterize the downtime by selecting from a plurality of characterization categories, each category being indicative of a different cause of downtime. The method may further include displaying the characterized downtime.

An exemplary method of using the disclosed system may include determining availability and reliability of the equipment by using the processor to process characterized operating status data to generate availability and reliability data. The method may also include displaying the availability and reliability data on the GUI. In some embodiments, the availability and reliability of a piece of equipment during a given time period may be determined by the processor only if all operating status data collected for the piece of equipment during the given time period has been characterized. The availability and reliability data may be determined in the manner described above.

In addition, an exemplary method of using the disclosed system may include automatically, initially categorizing any time with missing operating status data as uncharacterized and displaying at least some of the uncharacterized time with missing data to a user authorized to characterize downtime. The exemplary method may also include receiving input from the authorized user to characterize the time with missing data by selecting from a plurality of characterization categories, each category being indicative of a different operating status. The method may further include displaying the characterized time with missing data on the GUI.

The disclosed system may also be used for displaying the operating status data for a fleet of equipment on the GUI. An exemplary method of using the system may include isolating and displaying data for individual pieces of equipment in the fleet.

It will be apparent to those having ordinary skill in the art that various modifications and variations can be made to the disclosed equipment operating status tracking system without departing from the scope of the disclosed concept. Other embodiments will be apparent to those having ordinary skill in the art from consideration of the specification and practice of the concept disclosed herein. It is intended that the specification and examples be considered as exemplary only, with a true scope of the disclosed concept being indicated by the following claims and their equivalents.

What is claimed is:

1. An equipment operating status tracking system, comprising:
a graphical user interface (GUI);
a processor; and
a computer-readable medium operatively coupled to the processor and including a memory in which are stored instructions for:
receiving operating status data automatically collected for at least one piece of equipment;
automatically, initially categorizing any downtime in the operating status data as uncharacterized;
displaying, on the GUI, at least some of the operating status data, including the uncharacterized downtime, to a user authorized to characterize operating status data;
receiving input from the authorized user to characterize the downtime by selecting from a plurality of characterization categories, each category being indicative of a different cause of downtime; and
displaying the characterized downtime on the GUI.

2. The system of claim 1, wherein the characterization categories indicate whether the downtime is planned, unplanned, or caused by a problem with something other than the equipment from which data is collected.

3. The system of claim 1, wherein the computer-readable medium further includes instructions for:
determining availability and reliability of the equipment by using the processor to process characterized operating status data to generate availability and reliability data; and
displaying the availability and reliability data on the GUI.

4. The system of claim 3, wherein the availability and reliability of a piece of equipment during a time period is determined by the processor only if all operating status data collected during the time period has been characterized.

5. The system of claim 3, wherein the availability of the equipment is determined for a time period by subtracting planned downtime and unplanned downtime from the total amount of time in the time period and dividing by the total amount of time in the time period.

6. The system of claim 3, wherein the reliability of the equipment is determined for a time period by subtracting unplanned downtime from the total amount of time in the time period and dividing by the total amount of time in the time period.

7. The system of claim 1, wherein the characterization categories include two or more different categories of unplanned downtime, each unplanned downtime category corresponding to a different component of a system incorporating the at least one piece of equipment from which operating status data is automatically collected.

8. The system of claim 1, wherein the computer-readable medium further includes instructions for:
automatically, initially categorizing any time with missing operating status data as uncharacterized;
displaying, on the GUI, at least some of the uncharacterized time with missing data, to a user authorized to characterize downtime;
receiving input from the authorized user to characterize the time with missing data by selecting from a plurality of characterization categories, each category being indicative of a different operating status; and
displaying the characterized time with missing data on the GUI.

9. The system of claim 1, wherein the at least one piece of equipment is a fleet of equipment including pieces of equipment at two or more facilities; and
wherein a fleet manager responsible for managing operation of the fleet of equipment is the only entity with authorization to characterize the operating status data of the fleet.

10. The system of claim 1, wherein the computer-readable medium includes instructions for displaying and receiving information regarding characterized and uncharacterized operating status data via a web-based interface.

11. A method of tracking operating status of equipment, comprising:
receiving operating status data for at least one piece of equipment onto a computer-readable medium;
using a processor operatively coupled to the computer-readable medium to automatically, initially categorize any downtime in the operating status data as uncharacterized;
displaying, on a graphical user interface (GUI), at least some of the operating status data, including the uncharacterized downtime, to a user authorized to characterize downtime;
receiving input from the authorized user to characterize the downtime by selecting from a plurality of characterization categories, each category being indicative of a different cause of downtime; and
displaying the characterized downtime on the GUI.

12. The method of claim 11, wherein the characterization categories indicate whether the downtime is planned, unplanned, or caused by a problem with something other than the equipment from which data is collected.

13. The method of claim 11, further including:
determining availability and reliability of the equipment by using the processor to process characterized operating status data to generate availability and reliability data; and
displaying the availability and reliability data on the GUI.

14. The method of claim 13, wherein the availability and reliability of a piece of equipment during a time period is determined by the processor only if all operating status data collected during the time period has been characterized.

15. The method of claim 13, wherein the availability of the equipment is determined for a time period by subtracting planned downtime and unplanned downtime from the total amount of time in the time period and dividing by the total amount of time in the time period.

16. The method of claim 13, wherein the reliability of the equipment is determined for a time period by subtracting unplanned downtime from the total amount of time in the time period and dividing by the total amount of time in the time period.

17. The method of claim 11, wherein the characterization categories include two or more different categories of unplanned downtime, each unplanned downtime category corresponding to a different component of a system incorporating the at least one piece of equipment from which operating status data is automatically collected.

18. The method of claim 11, further including:
automatically, initially categorizing any time with missing operating status data as uncharacterized;
displaying, on the GUI, at least some of the uncharacterized time with missing data, to a user authorized to characterize downtime;
receiving input from the authorized user to characterize the time with missing data by selecting from a plurality of characterization categories, each category being indicative of a different operating status; and
displaying the characterized time with missing data on the GUI.

19. The method of claim 11, wherein the at least one piece of equipment includes is a fleet of equipment including pieces of equipment at two or more facilities; and
wherein a fleet manager responsible for managing operation of the fleet of equipment is the only entity with authorization to characterize the operating status data of the fleet.

20. The method of claim 11, further including displaying and receiving information regarding characterized and uncharacterized operating status data via a web-based interface.
